(19) United States
(12) Patent Application Publication
(10) Pub. No.: US 2017/0187463 A1
(43) Pub. Date: Jun. 29, 2017

(54) DELAY-BASED NONLINEAR EQUALIZER

(71) Applicant: Fujitsu Limited, Kawasaki-shi (JP)

(72) Inventor: Nikola Nedovic, San Jose, CA (US)

(21) Appl. No.: 14/980,657

(22) Filed: Dec. 28, 2015

(51) Int. Cl. H04B 10/50; H04L 27/01; H04B 10/58

(52) U.S. Cl. CPC H04B 10/503; H04B 10/58; H04L 27/01

(57) ABSTRACT

A method and system for implementing nonlinear transmitter equalization may employ a feed-forward equalizer that applies transition-dependent delays at each tap. Each delay element in a delay line may include independent controls for the delays to be applied to rising transitions and for the delays to be applied to falling transitions. Different delays may be applied to transitions between any two levels in a signal that is encoded using three or more analog levels. Different amounts of weighting may be applied to the output of each delay element in the delay line by respective tap weighing elements. A combiner circuit may generate an output for the equalizer as a linear combination of the weighted outputs of the delay elements. The output of the equalizer may be an input to a vertical cavity surface emitting laser (VCSEL) and may compensate for a nonlinearity of the VCSEL.

### BACKGROUND

Field of the Disclosure

The present disclosure relates generally to optical communication networks and, more particularly, to an optical transmitter that includes a vertical cavity surface emitting laser (VCSEL) and a Feed-Forward Equalizer (FFE) that implements transition-dependent tap delays.

Description of the Related Art

Telecommunication, cable television and data communication systems use optical networks to rapidly convey large amounts of information between remote points. In an optical network, information is conveyed in the form of optical signals through optical fibers. Optical fibers may comprise thin strands of glass capable of communicating the signals over long distances. Optical networks often employ modulation schemes to convey information in the optical signals over the optical fibers. Such modulation schemes may include phase-shift keying (PSK), frequency-shift keying (FSK), amplitude-shift keying (ASK), pulse-amplitude modulation (PAM), and quadrature amplitude modulation (QAM).

Optical networks may also include various optical elements, such as amplifiers, dispersion compensators, multiplexer/demultiplexer filters, wavelength selective switches (WSS), optical switches, couplers, etc. to perform various operations within the network. In particular, optical networks may include optical-electrical-optical (O-E-O) regeneration at reconfigurable optical add-drop multiplexers (ROADMs) when the reach of an optical signal is limited in a single optical path.

As data rates for optical networks continue to increase, reaching up to 1 terabit/s (1 T) and beyond, the demands on optical signal-to-noise ratios (OSNR) also increase. Vertical Cavity Surface Emitting Lasers (VCSELs) are widely used in high speed optical communications. To improve the effective bandwidth and data rate of communication, optical networks often implement feed-forward type transmitter equalization.

### SUMMARY

In one aspect, a disclosed nonlinear feed-forward equalizer may include a delay line that includes a plurality of delay elements, each of which is enabled to receive an input signal, add a delay to the input signal and produce an output signal for the delay element, and a respective delay line tap on the output of each delay element in the delay line. The nonlinear feed-forward equalizer may also include a combining circuit enabled to combine contributions from each of the respective delay line taps to generate an output signal of the nonlinear feed-forward equalizer. For a first one of the delay elements, the amount of the delay added to the input signal for rising transitions may be different than the amount of the delay added to the input signal for falling transitions.

In any of the disclosed embodiments of the nonlinear feed-forward equalizer, for a second one of the delay elements, the amount of the delay added to the input signal for rising transitions may be different than the amount of the delay added to the input signal for falling transitions, and the amount of the delay added to the input signal for rising transitions or for falling transitions may be different than the amount of the delay added to the input signal by the first one of the delay elements.

In any of the disclosed embodiments of the nonlinear feed-forward equalizer, to generate the output signal of the nonlinear feed-forward equalizer, the combining circuit may sum the contributions from each of the respective delay line taps.

In any of the disclosed embodiments, the nonlinear feed-forward equalizer may include a plurality of tap weighting circuits, each of which may apply a tap-specific weighting to a respective one of the delay line taps and may generate the contribution from the respective one of the delay line taps as a weighted contribution.

In any of the disclosed embodiments, the nonlinear feed-forward equalizer may include a plurality of tap weighting circuits, each of which may apply a tap-specific weighting to a respective one of the delay line taps and may generate the contribution from the respective one of the delay line taps as a weighted contribution. The tap-specific weighting applied to the delay line tap for a rising transition may be different than the tap-specific weighting applied to the delay line tap for a falling transition.

In any of the disclosed embodiments of the nonlinear feed-forward equalizer, each of the delay elements may include a first electrical path that controls the amount of the delay added to the input signal for rising transitions and a second electrical path that controls the amount of the delay added to the input signal for falling transitions.

In any of the disclosed embodiments of the nonlinear feed-forward equalizer, each of the first electrical path and the second electrical path in a given delay element may include an NMOS transistor and a PMOS transistor. The given delay element may receive a first pair of control voltages for the NMOS transistor and the PMOS transistor in the first electrical path that determine the amount of the delay added to the input signal on the first electrical path and a second pair of control voltages for the NMOS transistor and the PMOS transistor in the second electrical path that determine the amount of the delay added to the input signal on the second electrical path.

In any of the disclosed embodiments of the nonlinear feed-forward equalizer, for the first one of the delay elements, a delay may be added to the input signal for rising transitions and no delay may be added to the input signal for falling transitions.

In any of the disclosed embodiments of the nonlinear feed-forward equalizer, for the first one of the delay elements, a delay may be added to the input signal for falling transitions and no delay may be added to the input signal for rising transitions.

In a further aspect, a disclosed optical transmitter may include a nonlinear feed-forward equalizer that includes independent delay controls for different transition types exhibited by an input signal and a vertical cavity surface emitting laser (VCSEL). An output of the nonlinear feed-forward equalizer may be an input to the VCSEL.

In any of the disclosed embodiments of the optical transmitter, the nonlinear feed-forward equalizer may compensate for at least a portion of a nonlinearity of the VCSEL.

In any of the disclosed embodiments of the optical transmitter, the nonlinear feed-forward equalizer may include a plurality of delay elements, each of which may apply a different amount of delay to rising transitions exhibited by the input signal than to falling transitions exhibited by the input signal.

In any of the disclosed embodiments of the optical transmitter, the nonlinear feed-forward equalizer may apply longer delays to rising transitions exhibited by the input signal than to falling transitions exhibited by the input signal.

In any of the disclosed embodiments of the optical transmitter, the nonlinear feed-forward equalizer may apply longer delays to falling transitions exhibited by the input signal than to rising transitions exhibited by the input signal.

In any of the disclosed embodiments of the optical transmitter, the input signal may be encoded as a multilevel signal comprising three or more analog levels. The nonlinear feed-forward equalizer may include a plurality of delay elements, each of which may apply different amounts of delay for each of multiple different transitions between different ones of the three or more analog levels.

In a further aspect, a disclosed method is for optical transmission. The method may include, receiving, by a nonlinear feed-forward equalizer, an input signal to be transmitted over an optical network; directing the input signal to a first delay element in a delay line; applying, by the first delay element, a delay that is dependent on whether a rising transition is present in the input signal or a falling transition is present in the input signal to generate a first delayed output signal; and applying, by a first tap weighting element, a tap-specific weighting to the first delayed output signal to generate a first contribution to an output of the nonlinear feed-forward equalizer.

In any of the disclosed embodiments, the method may include, for each of one or more subsequent delay elements in the delay line and subsequent tap weighting elements, receiving a respective delayed output signal from a preceding delay element in the delay line as its input signal; applying, by the delay element, a delay that is dependent on whether a rising transition is present in its input signal or a falling transition is present in its input signal to generate a respective delayed output signal; applying, by the tap weighting element, a tap-specific weighting to the respective delayed output signal to generate a respective contribution to the output of the nonlinear feed-forward equalizer; combining the first contribution to the output for the nonlinear feed-forward equalizer and the respective contributions to the output for the nonlinear feed-forward equalizer for each of the one or more subsequent delay elements in the delay line and subsequent tap weighting elements to generate the output of the nonlinear feed-forward equalizer; and directing the output of the nonlinear feed-forward equalizer to a vertical cavity surface emitting laser (VCSEL) as an input signal.

In any of the disclosed embodiments of the method, the output of the nonlinear feed-forward equalizer may compensate for at least a portion of a nonlinearity of the VCSEL.

In any of the disclosed embodiments, the method may include determining that rising transitions or falling transitions of the input signal are under-equalized at a tap on the output of the first delay element or on one of the subsequent delay elements in the delay line. The method may also include, in response to the determination, decreasing the weighting for the tap and increasing the delay for transitions of the type that is under-equalized in the first delay element or in the one of the subsequent delay elements in the delay line.

In any of the disclosed embodiments, the method may include determining that rising transitions or falling transitions of the input signal are over-equalized at a tap on the output of the first delay element or on one of the subsequent delay elements in the delay line. The method may also include, in response to the determination, increasing the weighting for the tap and decreasing the delay for transitions of the type that is over-equalized in the first delay element or in the one of the subsequent delay elements in the delay line.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of selected elements of an embodiment of an optical network, according to at least some embodiments;

FIG. 2 is a block diagram illustrating selected elements of a conventional feed-forward equalizer (FFE) that applies a delay at each stage of a delay line;

FIG. 3 illustrates an example of the ideal characteristics of a conventional feed-forward equalizer;

FIG. 4 illustrates a graph representing a VCSEL transmitter pulse;

FIG. 5 is a block diagram illustrating selected elements of a feed-forward equalizer that applies transition-dependent delays at each stage of a delay line; according to at least some embodiments;

FIG. 6 is illustrates an example of the use of a feed-forward equalizer to generate a signal suitable for input to a VCSEL, according to at least some embodiments;

FIG. 7 is a block diagram illustrating selected elements of a delay line in a nonlinear feed-forward equalizer, according to one embodiment;

FIG. 8 is a block diagram illustrating selected elements of a delay line in a nonlinear feed-forward equalizer, according to another embodiment;

FIG. 9 is a flow diagram illustrating selected elements of a method of operation of an equalizer that includes transition-dependent delays, according to at least some embodiments; and

FIG. 10 is a flow diagram illustrating selected elements of a method for adjusting an equalizer configuration for a VCSEL circuit, according to at least some embodiments.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, as an example (not shown in the drawings), device “12-1” refers to an instance of a device class, which may be referred to collectively as devices “12” and any one of which may be referred to generically as a device “12”. In the figures and the description, like numerals are intended to represent like elements.

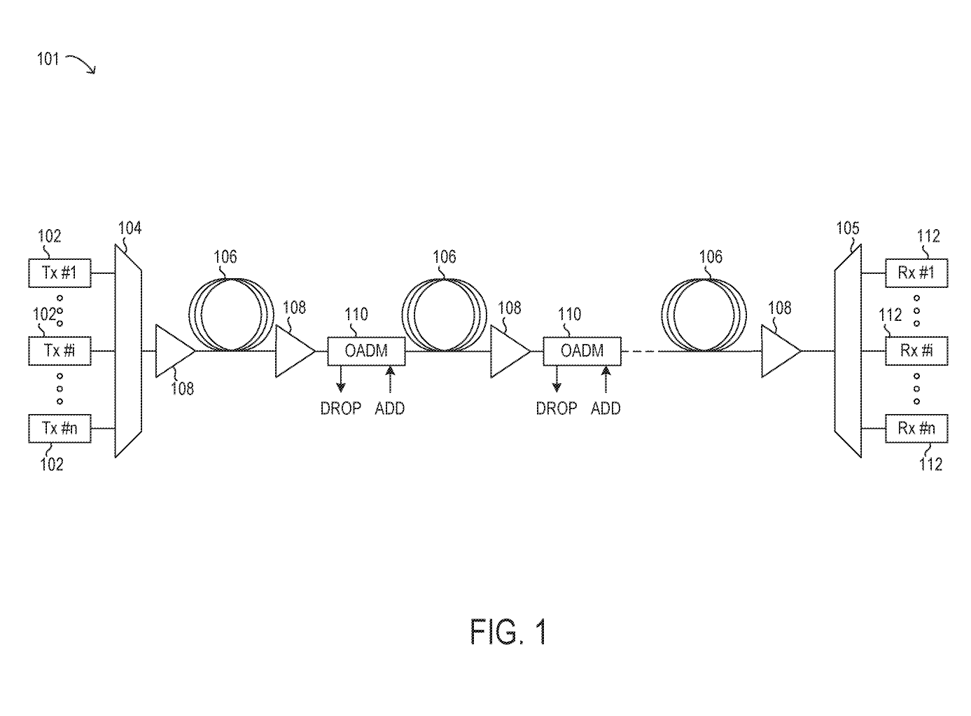

Referring now to the drawings, FIG. 1 illustrates an example embodiment of optical network 101, which may represent an optical communication system. Optical network 101 may include one or more optical fibers 106 to transport one or more optical signals communicated by components of optical network 101. The network elements of optical network 101, coupled together by fibers 106, may comprise one or more transmitters 102, one or more multiplexers (MUX) 104, one or more optical amplifiers 108, one or more optical add/drop multiplexers (OADM) 110, one or more demultiplexers (DEMUX) 105, and one or more receivers 112.

Optical network 101 may comprise a point-to-point optical network with terminal nodes, a ring optical network, a mesh optical network, or any other suitable optical network or combination of optical networks. Optical network 101 may be used in a short-haul metropolitan network, a long-haul inter-city network, or any other suitable network or combination of networks. The capacity of optical network 101 may include, for example, 100 Gbit/s, 400 Gbit/s, or 1 Tbit/s. Optical fibers 106 comprise thin strands of glass capable of communicating the signals over long distances with very low loss. Optical fibers 106 may comprise a suitable type of fiber selected from a variety of different fibers for optical transmission. Optical fibers 106 may include any suitable type of fiber, such as a Single-Mode Fiber (SMF), Enhanced Large Effective Area Fiber (E-LEAF), or TrueWave® Reduced Slope (TW-RS) fiber.

Optical network 101 may include devices to transmit optical signals over optical fibers 106. Information may be transmitted and received through optical network 101 by modulation of one or more wavelengths of light to encode the information on the wavelength. In optical networking, a wavelength of light may also be referred to as a channel that is included in an optical signal (also referred to herein as a “wavelength channel”). Each channel may carry a certain amount of information through optical network 101.

To increase the information capacity and transport capabilities of optical network 101, multiple signals transmitted at multiple channels may be combined into a single wideband optical signal. The process of communicating information at multiple channels is referred to in optics as wavelength division multiplexing (WDM). Coarse wavelength division multiplexing (CWDM) refers to the multiplexing of wavelengths that are widely spaced having low number of channels, usually greater than 20 nm and less than sixteen wavelengths, and dense wavelength division multiplexing (DWDM) refers to the multiplexing of wavelengths that are closely spaced having large number of channels, usually less than 0.8 nm spacing and greater than forty wavelengths, into a fiber. WDM or other multi-wavelength multiplexing transmission techniques are employed in optical networks to increase the aggregate bandwidth per optical fiber. Without WDM, the bandwidth in optical networks may be limited to the bit-rate of solely one wavelength. With more bandwidth, optical networks are capable of transmitting greater amounts of information. Optical network 101 may transmit disparate channels using WDM or some other suitable multi-channel multiplexing technique, and to amplify the multi-channel signal.

Optical network 101 may include one or more optical transmitters (Tx) 102 to transmit optical signals through optical network 101 in specific wavelengths or channels. Transmitters 102 may comprise a system, apparatus or device to convert an electrical signal into an optical signal and transmit the optical signal. For example, transmitters 102 may each comprise a laser and a modulator to receive electrical signals and modulate the information contained in the electrical signals onto a beam of light produced by the laser at a particular wavelength, and transmit the beam for carrying the signal throughout optical network 101.

Multiplexer 104 may be coupled to transmitters 102 and may be a system, apparatus or device to combine the signals transmitted by transmitters 102, e.g., at respective individual wavelengths, into a WDM signal.

Optical amplifiers 108 may amplify the multi-channeled signals within optical network 101. Optical amplifiers 108 may be positioned before or after certain lengths of fiber 106. Optical amplifiers 108 may comprise a system, apparatus, or device to amplify optical signals. For example, optical amplifiers 108 may comprise an optical repeater that amplifies the optical signal. This amplification may be performed with opto-electrical or electro-optical conversion. In some embodiments, optical amplifiers 108 may comprise an optical fiber doped with a rare-earth element to form a doped fiber amplification element. When a signal passes through the fiber, external energy may be applied in the form of an optical pump to excite the atoms of the doped portion of the optical fiber, which increases the intensity of the optical signal. As an example, optical amplifiers 108 may comprise an erbium-doped fiber amplifier (EDFA).

OADMs 110 may be coupled to optical network 101 via fibers 106. OADMs 110 comprise an add/drop module, which may include a system, apparatus or device to add and drop optical signals (for example at individual wavelengths) from fibers 106. After passing through an OADM 110, an optical signal may travel along fibers 106 directly to a destination, or the signal may be passed through one or more additional OADMs 110 and optical amplifiers 108 before reaching a destination.

In certain embodiments of optical network 101, OADM 110 may represent a reconfigurable OADM (ROADM) that is capable of adding or dropping individual or multiple wavelengths of a WDM signal. The individual or multiple wavelengths may be added or dropped in the optical domain, for example, using a wavelength selective switch (WSS) (not shown) that may be included in a ROADM.

As shown in FIG. 1, optical network 101 may also include one or more demultiplexers 105 at one or more destinations of network 101. Demultiplexer 105 may comprise a system apparatus or device that acts as a demultiplexer by splitting a single composite WDM signal into individual channels at respective wavelengths. For example, optical network 101 may transmit and carry a forty (40) channel DWDM signal. Demultiplexer 105 may divide the single, forty channel DWDM signal into forty separate signals according to the forty different channels.

In FIG. 1, optical network 101 may also include receivers 112 coupled to demultiplexer 105. Each receiver 112 may receive optical signals transmitted at a particular wavelength or channel, and may process the optical signals to obtain (e.g., demodulate) the information (i.e., data) that the optical signals contain. Accordingly, network 101 may include at least one receiver 112 for every channel of the network.

Optical networks, such as optical network 101 in FIG. 1, may employ modulation techniques to convey information in the optical signals over the optical fibers. Such modulation schemes may include phase-shift keying (PSK), frequency-shift keying (FSK), amplitude-shift keying (ASK), pulse-amplitude modulation (PAM), and quadrature amplitude modulation (QAM), among other examples of modulation techniques. In PSK, the information carried by the optical signal may be conveyed by modulating the phase of a reference signal, also known as a carrier wave, or simply, a carrier. The information may be conveyed by modulating the phase of the signal itself using two-level or binary phase-shift keying (BPSK), four-level or quadrature phase-shift keying (QPSK), multi-level phase-shift keying (M-PSK) and differential phase-shift keying (DPSK). In QAM, the information carried by the optical signal may be conveyed by modulating both the amplitude and phase of the carrier wave. PSK may be considered a subset of QAM, wherein the amplitude of the carrier waves is maintained as a constant.

Additionally, polarization division multiplexing (PDM) technology may enable achieving a greater bit rate for information transmission. PDM transmission comprises independently modulating information onto different polarization components of an optical signal associated with a channel. In this manner, each polarization component may carry a separate signal simultaneously with other polarization components, thereby enabling the bit rate to be increased according to the number of individual polarization components. The polarization of an optical signal may refer to the direction of the oscillations of the optical signal. The term “polarization” may generally refer to the path traced out by the tip of the electric field vector at a point in space, which is perpendicular to the propagation direction of the optical signal.

In an optical network, such as optical network 101 in FIG. 1, it is typical to refer to a management plane, a control plane, and a transport plane (sometimes called the physical layer). A central management host (not shown) may reside in the management plane and may configure and supervise the components of the control plane. The management plane includes ultimate control over all transport plane and control plane entities (e.g., network elements). As an example, the management plane may include a central processing center (e.g., the central management host), including one or more processing resources, data storage components, etc. The management plane may be in electrical communication with the elements of the control plane and may also be in electrical communication with one or more network elements of the transport plane. The management plane may perform management functions for an overall system and provide coordination between network elements, the control plane, and the transport plane. As examples, the management plane may include an element management system (EMS) which handles one or more network elements from the perspective of the elements, a network management system (NMS) which handles many devices from the perspective of the network, and an operational support system (OSS) which handles network-wide operations.

Modifications, additions or omissions may be made to optical network 101 without departing from the scope of the disclosure. For example, optical network 101 may include more or fewer elements than those depicted in FIG. 1. Also, as mentioned above, although depicted as a point-to-point network, optical network 101 may comprise any suitable network topology for transmitting optical signals such as a ring, a mesh, and a hierarchical network topology.

As discussed above, the amount of information that may be transmitted over an optical network may vary with the number of optical channels coded with information and multiplexed into one signal. Accordingly, an optical fiber employing a WDM signal may carry more information than an optical fiber that carries information over a single channel. Besides the number of channels and number of polarization components carried, another factor that affects how much information may be transmitted over an optical network may be the bit rate of transmission. The higher the bit rate, the greater the transmitted information capacity. Achieving higher bit rates may be limited by the availability of wide bandwidth electrical driver technology, digital signal processor technology and increases in the required OSNR for transmission over optical network 101.

As previously noted, Vertical Cavity Surface Emitting Lasers (VCSELs) are often used in high speed optical communications. Unlike other semiconductor lasers that are edge-emitting, VCSELs are semiconductor laser diodes that emit laser beams at an angle perpendicular to their top surface. In a VCSEL, the laser resonator includes two mirrors that are parallel to the wafer surface with one or more quantum wells for the laser light generation in between. VCSELs have a larger output aperture than most edge-emitting lasers, and produce a lower divergence angle of the output beam. For this and other reasons (including a low threshold current, and lower power consumption than most edge-emitting lasers), they are suitable for coupling with optical fibers. However, VCSELs typically have lower emission power than edge-emitting lasers and exhibit inherent nonlinearity.

As data rates for communication networks (including optical communication networks) continue to increase, inter-symbol interference (ISI) becomes a more significant problem than it was in communication networks operating at lower data rates. For example, at a data rate of 10 gigabits per second, ISI may cause complete eye closure within a very short distance (e.g., a few inches of trace on a printed circuit board, a few feet of copper cable, or a few dozen yards of multimode optical fiber). The ISI may also change over time with changing physical conditions, such as changes in temperature, the bending of a printed circuit board or cable, or the presence (or an increase) in vibrations in the system. In some systems, in an attempt to mitigate the effects of ISI, a filter may be applied to flatten the frequency response of the channel. This process, which may be referred to, generally, as equalization, may be applied at either the transmitters or receivers in a communication network. When equalization is applied at the transmitter it may sometimes be referred to as a “pre-emphasis” or “de-emphasis” improvement. Pre-emphasis often used in channels where the channel response is sufficiently well known in advance (e.g., in copper cables).

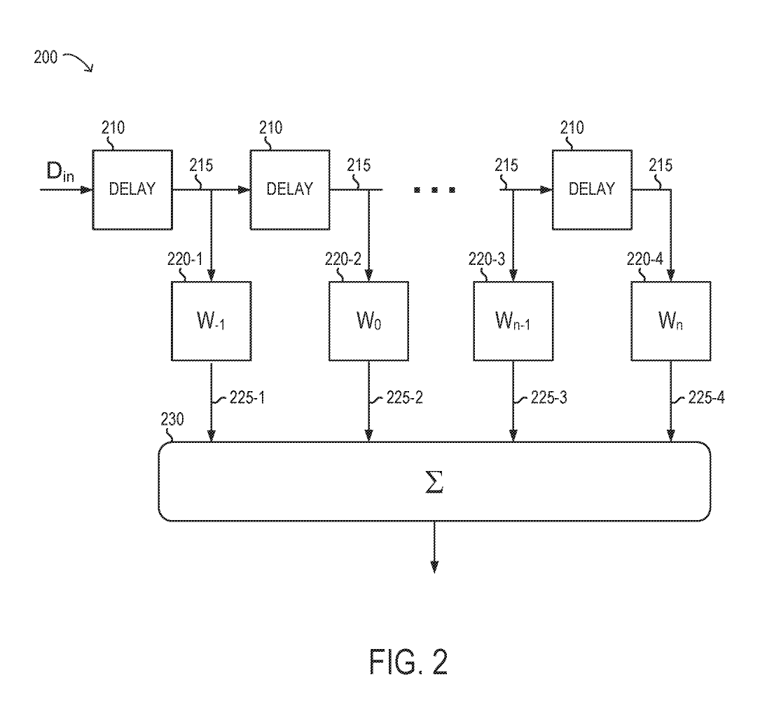

To improve the effective bandwidth and data rate, communication networks often employ one or more equalization techniques, all of which come with different engineering trade-offs, including trade-offs in power consumption, performance, and/or cost. One approach that is commonly used in communications networks is feed-forward equalization. This approach typically includes a finite impulse response filter (FIR) with a series of tap weights that are programmed to adjust the impulse response and the frequency response of an input signal. A feed-forward equalizer may be implemented entirely in the analog domain. This approach may be used in very high speed communication networks with relatively low power consumption. However, the performance of feed-forward equalization is, in most cases, insufficient for optical networks operating the range of tens of gigabits per second. An example implementation of a conventional feed-forward equalizer is illustrated in FIG. 2 and described below.

FIG. 2 is a block diagram illustrating selected elements of a conventional feed-forward equalizer (FFE) 200 that applies a delay at each stage of a delay line. In this example, equalizer 200 includes multiple delay elements 210 and corresponding tap weighting elements 220, as well as a combiner circuit 230. Each of the delay elements 210 applies a delay to its input signal to generate a delayed output signal 215 that is directed to the next delay element in the delay line (if any exists) as input.

As illustrated in FIG. 2, the delayed output signal 215 from each of the delay elements 210 is tapped and directed to a respective one of the tap weighting elements 220. In this example, the input to the equalizer, which is labeled Dᵢₙ, is directed to the first delay element in the delay line. The output 215 of the first delay element 210 is directed to weighting element 220-1 (labeled as W₋₁) and to the second delay element 210 in the delay line. Similarly, the output 215 of the second delay element 210 is directed to weighting element 220-2 (labeled as W₀) and to the next delay element in the delay line (not shown). In this example, the output 215 of the penultimate delay element is directed to weighting element 220-3 (labeled as Wₙ₋₁) and to the last delay element 210 in the delay line. The output 215 of the last delay element 210 is directed to weighting element 220-4 (which is labeled Wₙ).

In this example, each of the tap weighting elements 220 may multiply the output 215 of one of the delay elements 210 by a tap-specific weight to generate a respective weighted delayed output 225 and may direct that weighted delayed output to combiner circuit 230. In some embodiments, the weighting applied to two or more of the taps may be different from each other. For example, weighting element 220-1 (labeled W₋₁) may apply a tap-specific weight to a delayed output signal 215 to generate a weighted delayed output 225-1. Similarly, weighting element 220-2 (labeled W₀) may apply a tap-specific weight to a delayed output signal 215 to generate weighted delayed output 225-2; weighting element 220-3 (labeled Wₙ₋₁) may apply a tap-specific weight to a delayed output signal 215 to generate weighted delayed output 225-3; and weighting element 220-4 (labeled W₀) may apply a tap-specific weight to a delayed output signal 215 to generate a weighted delayed output 225-4.

In the example embodiment illustrated in FIG. 2, combiner circuit 230 may generate an output for equalizer 200 (labeled as Dₒᵤₜ) through the linear combination of the weighted delayed outputs 225. For example, Dₒᵤₜ may be generated as the sum of the weighted delayed outputs 225, in some embodiments. In other embodiments, combiner circuit 230 may generate Dₒᵤₜ using another combination of the weighted delayed outputs 225.

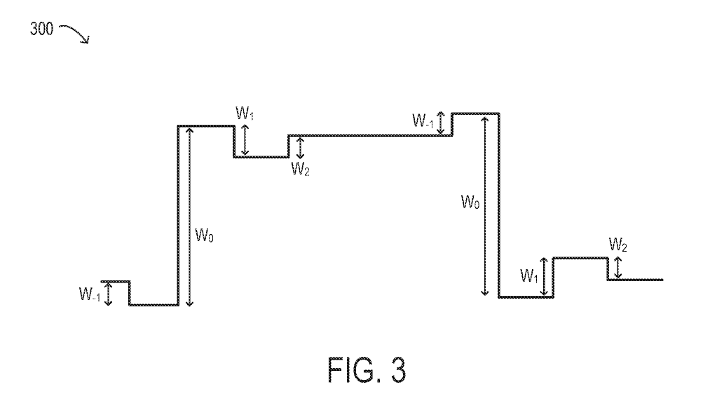

FIG. 3 illustrates an example of the ideal characteristics of a conventional feed-forward equalizer (such as that illustrated in FIG. 2) for an input signal that transitions from 0 to 1 and then from 1 to 0. For example, the waveform 300 illustrated in FIG. 3 includes, for the rising transition, contributions from each of four tap weighing elements, the amplitudes of which are shown as the first set of labels W-1, W0, W1, and W2. The waveform 300 illustrated in FIG. 3 also includes, for the falling transition, contributions from each of four tap weighing elements, the amplitudes of which are shown as the second set of labels W-1, W0, W1, and W2.

As previously noted, VCSELs exhibit inherent nonlinearity effects, which may be more pronounced (or have a greater negative effect) when dealing with multilevel signals. For example, if the amplitude at the inputs or outputs of a VCSEL is large enough, there are certain regions in its operation in which (due to physics, e.g., carrier concentration and photon density/concentration) it starts behave nonlinearly. In some regions, if too little current is put through the VCSEL, it may have difficulty determining whether to emit a laser beam. In some regions, if too much current is put through the VCSEL, there may be issues with self-heating and the effects of the self-heating. For example, the device may heat up, which may cause the efficiency to go down. In this case, the gain of the VCSEL may begin to drop, which acts as a type of nonlinearity. In order to achieve good performance and to operate at something close to the linear range, these two regions are to be avoided. These constraints may not leave much space in which to operate, and may limits the amplitude available from the VCSEL. This may be especially true if certain types of equalization are employed. For example, the equalization may amplify one range of frequencies and attenuate another, leaving less available range (or swing) than without the equalization. In other words, when attempting to operate a VCSEL within the linear range (or close to the linear range), the amplitude range may be very limited.

In one example, if an input signal is encoded to represent data values of 0 and 1, and if the data represented by the signal is 0, but starts to switch to 1, the waveform and the characteristics will look very different compared to the case in which the data represented by the signal is going from 1 to 0. This is indicative of a channel that is not linear. Therefore, adding linear equalization to the input of the VCSEL is not likely to improve the situation. In other words, if the equalization is not able to distinguish between data values based on the input (e.g., the input strength or power or some other characteristic), but it behaves substantially the same whether biased at zero or biased at one, it will not be able to compensate for any nonlinearity of the VCSEL. This may be especially problematic for multilevel signals. For example, an input signal encoded using PAM4 may, rather than representing a series of single bits (zeros and ones), represent a pair of bits using four analog signal levels. In this example, the lowest amplitude signal level may represent an encoding of 00, the next lowest amplitude signal level may represent an encoding of 01, and so on. In some embodiments, when the input signal is encoded using PAM4 modulation (in which the signal encodes two bits at a time), the transmitter may be even more sensitive to the amplitude. In other words, even with the additional of a linear equalizer, the inputs and outputs of the VCSEL may not have sufficient amplitude to be able to distinguish between all four cases for the two-bit encoded in the signal.

In some cases, the structure of VCSELs may result in a phenomenon referred to as “off-state bounce”. As described in the literature (e.g., in Application Note AN-2135, published by the Finisar Corporation), the basic cause of this off-state bouncing may be that VCSEL modes are spatially separated and surrounded by regions that are forward-biased, but not lasing. When a lasing region is turned off, a charge carrier gradient is produced which draws carriers from the surrounding material, briefly raising the region back above the carrier density required for lasing. This produces a small power “bounce” up to several hundred picoseconds after the pulse falling edge. Depending on the VCSEL geometry and the speed of the driving circuitry, this bounce may be separated from the falling edge or may blend with it, increasing the apparent fall time. In cases in which this blended behavior is observed, the information in the original signal may be distorted.

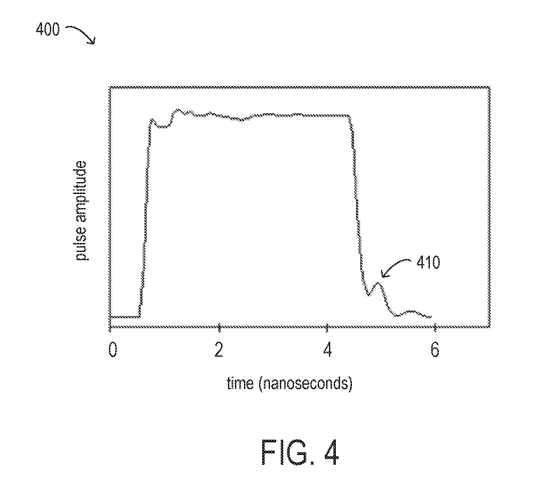

An example step VCSEL response, which also exhibits off-state bounce behavior (as described in the application note referenced above) is illustrated in FIG. 4. More specifically, the waveform illustrated in graph 400 represents a VCSEL transmitter pulse including a transition from 0 to 1, followed by a transition from 1 to 0. As illustrated in this example, the characteristics of the VCSEL may be different for rising transitions than for falling transitions. In addition, the waveform illustrated in FIG. 4 includes a larger than usual off-state bounce component 410. In this example, the y-axis represents the amplitude of the pulse amplitude (in arbitrary units), and the x-axis represents time (in nanoseconds).

Some existing approaches for applying nonlinear equalization to compensate for nonlinearities in VCSELs or other types of lasers include approaches that rely on the generation of extremely short pulses or the use of nonlinear materials. Another approach, which has been primarily used for equalization of electrical channels, performs nonlinear equalization in the digital domain.

The nonlinear equalization approach described herein employs a feed-forward type approach. However, unlike in a conventional FFE, the equalizers disclosed herein apply intentionally unequal, transition-dependent delays at each stage in the delay line. In other words, the delays between the taps are different depending on whether the input signal is exhibiting a rising transition or a falling transition. In some embodiments of the present disclosure, this nonlinear transmitter equalization approach may be targeted to VCSELs and may compensate for at least a portion of the inherent nonlinearity effects of VCSELs. In some embodiments, this nonlinear transmitter equalization approach may be suitable for scaling to very high data rates (e.g., tens of gigabits per second or higher). In some embodiments, the equalizers disclosed herein may provide different delays for rising and falling transitions or may provide different delays for all of the different signal levels in multi-level signaling schemes. In other words, in some embodiments, this approach may be applied to achieve different equalization strengths for different levels of a multilevel transmitter (e.g., for PAM-4 signaling).

In some embodiments of the present disclosure, the nonlinear equalizer may apply longer delays for low to high transitions (or from one of multiple levels to a higher level) than for high to low transitions (or from one of multiple levels to a lower level). In such embodiments, the intermediate (and weighted) signals may be added or subtracted, resulting in a different waveform on the rising edge compared to the falling edge. This translates to nonlinearity in the equalization. In other embodiments, the nonlinear equalizer may apply longer delays for high to low transitions than for low to high transitions. In some embodiments, the weighting applied to a particular tap may be different for rising edges than for falling edges. In other embodiments, the weighting applied to a particular tap may be substantially the same for both rising edges and falling edges (e.g., in embodiments in which the weighting is applied to the level of the signal after it is generated by a particular delay element). In some embodiments, the weighting applied to the taps is linear (e.g., the output of the tap weighting elements is generated by multiplying the output of a delay element by a constant value). In other embodiments, the tap weighting elements may include nonlinear elements that result in a nonlinear gain.

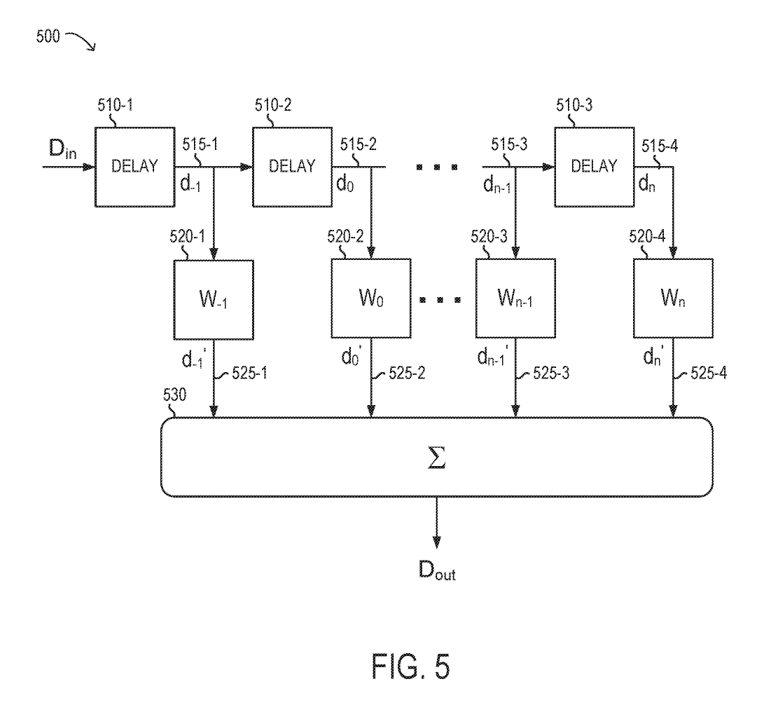

FIG. 5 is a block diagram illustrating selected elements of a feed-forward equalizer 500 that applies transition-dependent delays at each stage of a delay line. In this example, equalizer 500 includes multiple delay elements 510 and corresponding tap weighting elements 520, as well as a combiner circuit 530. Each of the delay elements 510 applies a transition-dependent delay to its input signal to generate a delayed output signal 515 that is directed to the next delay element in the delay line (if any exists) as input. For example, the delay applied to the input signal of a given delay element may be different when the input signal exhibits a rising transition (e.g., from a value representing 0 to a value representing 1, or from a value representing one level in a multilevel encoding to a value representing a higher level in the multi-level encoding) than when it exhibits a falling transition (e.g., from a value representing 1 to a value representing 0, or from a value representing one level in a multilevel encoding to a value representing a lower level in the multi-level encoding).

As illustrated in FIG. 5, the delayed output signal 515 from each of the delay elements 510 is tapped and directed to a respective one of the tap weighting elements 520. In this example, the input to the equalizer, which is labeled Dᵢₙ, is directed to the first delay element in the delay line (510-1), and the output of delay element 510-1 (signal 515-1, which is labeled d₋₁) is directed to weighting element 520-1 (labeled as W₋₁) and to the second delay element in the delay line (510-2). The output of delay element 510-2 (signal 515-2, which is labeled d₀) is directed to weighting element 520-2 (labeled as W₀) and to the next delay element in the delay line (not shown). In this example, the output of the penultimate delay element (signal 515-2, which is labeled 4₋₁) is directed to weighting element 520-3 (which is labeled as Wₙ₋₁) and to the last delay element in the delay line (510-3). The output of delay element 510-3 is directed to weighting element 520-4 (which is labeled Wₙ).

In this example, each of the tap weighting elements 520 may multiply the output 515 of one of the delay elements 510 by a tap-specific weight to generate a respective weighted delayed output 525 and may direct that weighted delayed output to combiner circuit 530. In some embodiments, the weighting applied to two or more of the taps may be different from each other. For example, weighting element 520-1 (labeled W₋₁) may apply a tap-specific weight to delayed output signal 515-1 (d₋₁) to generate weighted delayed output 525-1 (labeled d₋₁′). Similarly, weighting element 520-2 (labeled W₀) may apply a tap-specific weight to delayed output signal 515-2 (d₀) to generate weighted delayed output 525-2 (labeled d₀′); weighting element 520-3 (labeled Wₙ₋₁) may apply a tap-specific weight to delayed output signal 515-3 (dₙ₋₁) to generate weighted delayed output 525-3 (labeled dₙ₋₁′); and weighting element 520-4 (labeled WO may apply a tap-specific weight to delayed output signal 515-4 (dₙ) to generate weighted delayed output 525-4 (labeled dₙ′). In some embodiments, the weighting applied to a given tap when it represents a falling transition may be different than the weighting applied to the given tap when it represents a rising transition (not shown).

In the example embodiment illustrated in FIG. 5, combiner circuit 530 may generate an output for equalizer 500 (labeled as Dₒᵤₜ) through the linear combination of the weighted delayed outputs 525. For example, Dₒᵤₜ may be generated as the sum of the weighted delayed outputs 525, in some embodiments. In other embodiments, combiner circuit 530 may generate Dₒᵤₜ using another combination of the weighted delayed outputs 525. In some embodiments, Dₒᵤₜ may be directed to an input of a VCSEL of an optical transmitter in an optical communication network, such as one of the transmitters 102 illustrated in FIG. 1. For example, the optical network 101 may include a respective instance of equalizer 500 for each one of multiple optical channels.

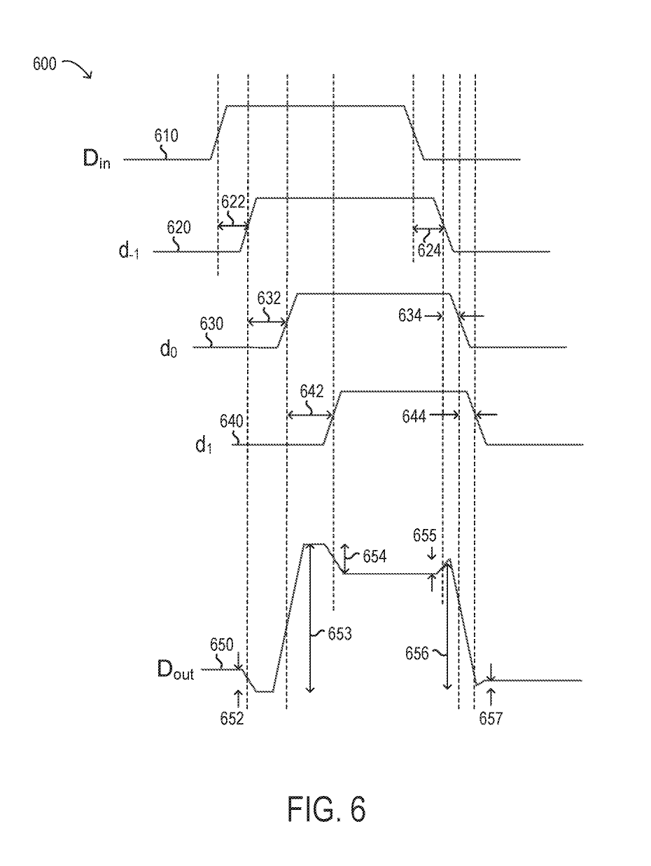

FIG. 6 illustrates an example of the use of a feed-forward equalizer that applies transition-dependent delays at each stage of a delay line to generate a signal suitable for input to a VCSEL, according to at least some embodiments. More specifically, FIG. 6 depicts a group of waveforms 600 representing an input to the equalizer (input signal 610, labeled as Dᵢₙ), an output of the equalizer (output signal 650, labeled as Dₒᵤₜ), and three constituent delayed output signals (signal 620, labeled as d₋₁, signal 630, labeled as d₀, and signal 640, labeled as d₁) that are generated by three delay elements in the delay line. In this example, the three constituent delayed output signals are subsequently weighted and combined (e.g., by corresponding tap weighting elements) to create the output of the equalizer. In some embodiments, an equalizer that behaves as depicted in FIG. 6 may be similar in structure to equalizer 500 illustrated in FIG. 5, but may include only three delay elements in the delay line (i.e., n=1).

In this example, 622 represents the delay that was applied to the input (signal 610, Dᵢₙ) by the first delay element for the rising transition of signal 610, and 624 represents the delay that was applied to the input (signal 610) by the first delay element for the falling transition of signal 610. In this example the first delay element applies substantially the same delay to the rising transition of input signal Dᵢₙ as to the falling transition of input signal Dᵢₙ (i.e. delay 622 is substantially equal to delay 624). Therefore, the output of the first delay element (signal 620, d₋₁) has substantially the same shape as the input signal Dᵢₙ. In this example, 632 represents the delay that was applied to the output of the first delay element (signal 620) by the second delay element for the rising transition of signal 620, and 634 (which is much narrower than delay 632) represents the delay that was applied to the output of the first delay element (620) by the second delay element for the falling transition of signal 620. Similarly, 642 represents the delay that was applied to the output of the second delay element (signal 630) by the third delay element for the rising transition of signal 630, and 644 (which is much narrower than delay 642) represents the delay that was applied to the output of the second delay element (signal 630) by the third delay element for the falling transition of signal 630.

The shape of the composite output signal Dₒᵤₜ is dependent on the delays illustrated in the signals 620, 630, and 640, as well as on the weighting applied by corresponding tap weighting elements. For example, the transition whose amplitude is represented as 652 in

FIG. 6 is a function of a negative weighting applied to signal 620 by the first tap weighting element and the delay 632 introduced by the second delay element. The delay 632 affects the width of the portion of output signal Dₒᵤₜ between transition 652 and the large rising transition whose amplitude is shown as 653. The transition whose amplitude is represented as 653 is a function of a positive weighting applied to signal 630 by the second tap weighting element and the delay 642 introduced by the third delay element. The delay 642 affects the width of the portion of output signal Dₒᵤₜ between transition 653 and the transition whose amplitude is shown as 654. The transition whose amplitude is represented as 654 is a function of a negative weighting applied to signal 640 by the third tap weighting element.

In this example, the transition whose amplitude is represented at 655 is a function of a weighting applied to signal 620 by the first tap weighting element and the delay 634 introduced by the second delay element. Similarly, the transition whose amplitude is represented at 656 is a function of a weighting applied to signal 630 by the second tap weighting element and the delay 644 introduced by the third delay element; and the transition whose amplitude is represented by 657 is a function of a weighting applied to signal 640 by the third tap weighting element.

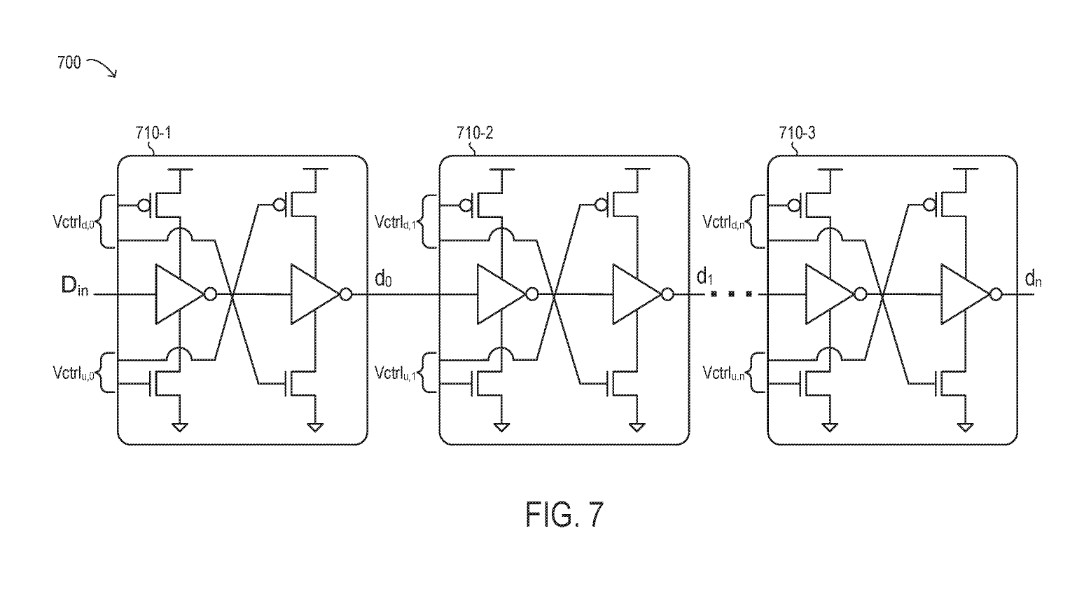

In various embodiments, the techniques described herein for nonlinear transmitter equalization may be implemented using any suitable type of delay line circuitry that is enabled to apply transition-dependent delays at one or more stages of a feed-forward type equalizer. For example, FIG. 7 is a block diagram illustrating selected elements of a delay line in a feed-forward equalizer that applies transition-dependent delays to the signals that pass through each delay element, according to one embodiment. In this example, equalizer 700 includes at least three delay elements 710 (shown as 710-1, 710-2, 710-3). However, as depicted by the ellipsis between delay element 710-2 and 710-3, equalizer 700 may include more delay elements than are depicted in FIG. 7. In this example, each of the delay elements 710 includes a path comprising a PMOS transistor shown at the top left of the delay element and an NMOS transistor shown at the bottom right of the delay element. The circuit elements on this path determine the delay for an input signal that transitions from 1 to 0 (i.e., a falling transition). More specifically, for delay element 710-1, the delay determined by this path is controlled by a pair of voltages shown collectively as Vctrl_{d,0}. For example, the voltages provided to the NMOS and PMOS transistors in this path may have substantially equal values and opposite polarities. Similar paths that determine the delays for falling transitions in delay elements 710-2 and 710-3 are controlled by a pair of voltages shown collectively as Vctrl_{d,1} and a pair of voltages shown collectively as Vctrl_{d,n}, respectively.

In this example embodiment, each delay element 710 also includes a path comprising an NMOS transistor shown at the bottom left of the delay element and a PMOS transistor shown at the top right of the delay element. The circuit elements on this path determine the delay for an input signal that transitions from 0 to 1 (i.e., a rising transition). More specifically, for delay element 710-1, the delay determined by this path is controlled by a pair of voltages shown collectively as Vctrl_{u,0}. For example, the voltages provided to the NMOS and PMOS transistors in this path may have substantially equal values and opposite polarities. Similar paths that determine the delays for rising transitions in delay elements 710-2 and 710-3 are controlled by a pair of voltages shown collectively as Vctrl_{u,1} and a pair of voltages shown collectively as Vctrl_{u,n}, respectively.

In this example implementation, the control voltages for the rising transition delay paths and the falling transition delay paths in each delay element 710 are different. Therefore, by adjusting the relative sizes of these control voltages, the rising transition delays and the falling transition delays may be independently controlled. In this example, decreasing the control voltage to the NMOS transistor and increasing the voltage to the PMOS transistor in one of these paths will increase the delay for the corresponding transition. Conversely, decreasing the control voltage to the PMOS transistor and increasing the voltage to the NMOS transistor in one of these paths will decrease the delay for the corresponding transition.

In this example, the output of delay element 710-3, which is labeled dₙ may be directed to another delay element in equalizer 700, in some embodiments, (if there are any additional delay elements in the delay line). In various embodiments, the outputs of each of the delay elements 710 may be directed to a respective tap weighting element (the output of which may be directed to a combining circuit) or may be directed to a combining circuit without additional weighting. The output of the combining circuit may be directed to an input of a VCSEL, and may compensate for the phase characteristics inherent in the VCSEL, in some embodiments.

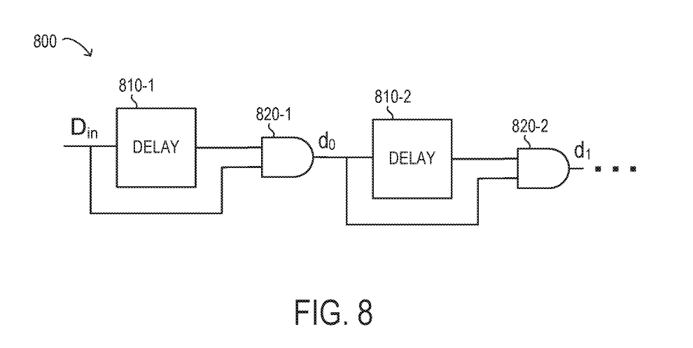

As noted above, the delay line circuitry of the nonlinear equalizers described herein may take a variety of forms, in different embodiments. FIG. 8 is a block diagram illustrating selected elements of a delay line 800 in a feed-forward equalizer that applies transition-dependent delays to the signals that pass through each delay element, according to another embodiment. In this example, the delay line includes at least two delay elements 810 (e.g., 810-1 and 810-2), each of which may apply substantially the same delay or a different delay to its input signal when the input signal exhibits a rising transition. In this example, the delayed signals produced by delay elements 810-1 and 810-2 are directed to corresponding logic gates 820 (e.g., 820-1 and 820-2, respectively). As depicted by the ellipsis following logic gate 820-2, equalizer 800 may include more delay elements than are depicted in FIG. 8.

In this example, which implements a coarser approach to transition-dependent delays than the example embodiment illustrated in FIG. 7, a falling transition then completely bypasses the delay elements 810 (passing straight through delay line 800 without incurring any added delay).

In the example embodiment illustrated in FIG. 8, each logic gate 820 generates an input for a subsequent delay element 810 (as long as there are additional delay elements in delay line 800). In some embodiments, these outputs (shown as d₀ and d₁) may be tapped and directed to corresponding tap weighting elements, the outputs of which may be combined to generate an output for equalizer 800. In another embodiment, by replacing the logic gates 820 with OR gates, rather than AND gates, equalizer 800 may be enabled to delay only falling transitions, while rising transitions pass through without additional delay.

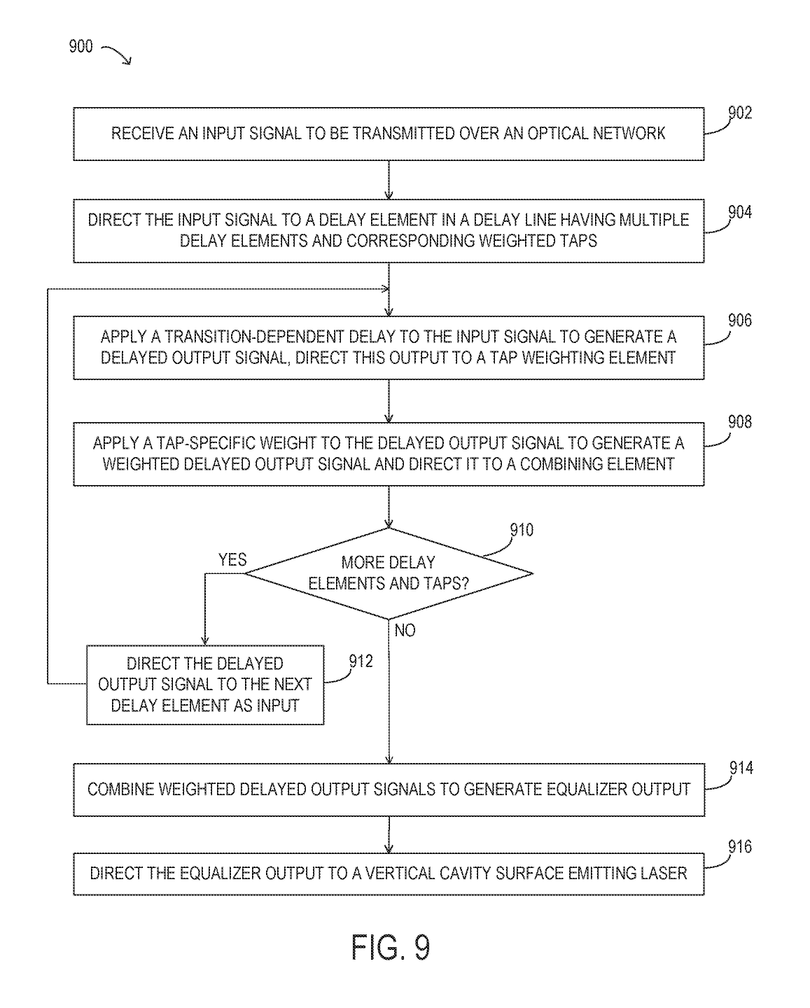

The method of operation for the nonlinear equalizers disclosed herein may be similar regardless of the delay line circuitry used to implement them. For example, FIG. 9 is a flow diagram illustrating selected elements of a method of operation 900 of an equalizer that includes transition-dependent delays, according to at least some embodiments. As illustrated at step 902, in this example, the method may include receiving an input signal that is to be transmitted over an optical network. The method may also include, at step 904, directing the input signal to a delay element in a delay line that includes multiple delay elements and corresponding weighted taps. For example, the input signal may be directed to the first of multiple delay elements in the delay line.

As illustrated in FIG. 9, the method may include, at step 906, applying a transition-dependent delay to the input signal to generate a delayed output signal, and directing this delayed output signal to a corresponding one of multiple tap weighting elements. The method may also include, at step 908, applying a tap-specific weight to the delayed output signal to generate a weighted delayed output signal, and directing the weighted delayed output signal to a combining element. If there more delay elements and taps (as determined at step 910), the method may include, at step 912, directing the delayed output signal to the next delay element as input. In this case, the operations shown in steps 906 and 908 may be performed by the next delay element in the delay line. This next delay element in the delay line may operate on the output of the previous delay element to generate an additional delayed output and may direct the additional delayed output to a corresponding weighting element (e.g., a different one of multiple tap weighting elements), which may generate an additional weighted delayed output and direct that additional weighted delayed output to the combining element. These steps may be repeated any number of times until all of the delay elements and corresponding tap weighting elements have processed the input signal (or modified versions thereof) and all contributions to the equalizer output have been generated by these elements and have been directed to the combining element.

As illustrated in this example, once all contributions to the equalizer output have been generated and directed to the combining element, the method may include, at step 914, combining all of the weighted delayed output signals that were received from the tap weighting elements to generate an equalizer output. The method may also include, at step 916, directing the equalizer output to a vertical cavity surface emitting laser as input.

In some embodiments, the nonlinear equalizers disclosed herein may be dynamically adjusted (e.g., at runtime) to compensate for nonlinearities of a VCSEL that receives the output of the equalizer. For example, in some embodiments, the voltages applied to control the delays (and relative delays) for rising and falling transitions and/or the weighting applied to different taps may be modified during operation if the rising or falling transitions are under-equalized or over-equalized. Note that a change in the weighting for a particular tap may affect its contribution to the output for both the rising and falling transitions. However, a change made to one of the voltages that controls delay in a particular delay element may affect only the rising transitions or only the falling transitions.

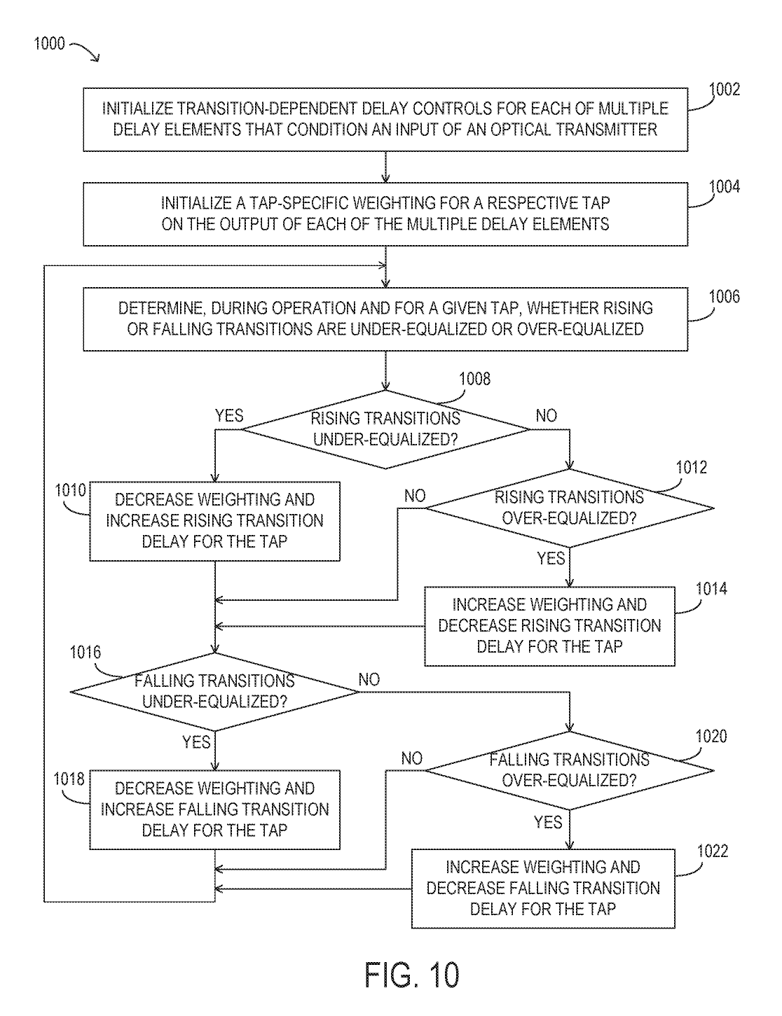

FIG. 10 is a flow diagram illustrating selected elements of a method 1000 for adjusting an equalizer configuration for a VCSEL circuit to effect the extension of communication speed and signal amplitude of the VCSEL, according to at least some embodiments. As illustrated at step 1002, the method may include initializing transition-dependent delay controls for each of multiple delay elements that condition an input of an optical transmitter. The method may also include, at step 1004, initializing a tap-specific weighting for a respective tap on the output of each of the multiple delay elements. At step 1006, the method may include determining, during operation and for a given tap, whether or not rising and/or falling transitions are under-equalized or over-equalized.

If, at decision block 1008, it is determined that rising transitions are under-equalized, the method may include, at step 1010, decreasing the weighting on the given tap and increasing the delay on rising transitions for the given tap. If, at decision block 1012, it is determined that rising transitions are over-equalized, the method may include, at step 1014, increasing the weighting on the given tap and decreasing the delay on rising transitions for the given tap. Similarly, if, at decision block 1016, it is determined that falling transitions are under-equalized, the method may include, at step 1018, decreasing the weighting on the given tap and increasing the delay on falling transitions for the tap. If, at decision block 1020, it is determined that falling transitions are over-equalized, the method may include, at step 1022, increasing the weighting for the given tap and decreasing the delay on falling transitions for the given tap.

As illustrated by the paths from steps 1018, 1020, and 1022 to step 1006, method 1000 may be repeated one or more times (e.g., periodically or continuously) during operation of the equalizer, in some embodiments. In some embodiments, method 1000 may be performed to adjust the equalization configuration for each of the multiple taps in the delay line in parallel, serially, and/or in any arbitrary order to generate an acceptable equalizer output through the combination of these contributions (e.g., to generate an equalizer output that compensates for inherent nonlinearities of a VCSEL element in an optical transmitter).

Note that, in some embodiments, an optical transmitter that includes a VCSEL and a nonlinear feed-forward type equalizer that applies transition-dependent delays to an input signal may also include one or more other types of equalizers. In addition, and optical network that includes one or more equalizers in its transmitters (including a nonlinear feed-forward type equalizer that applies transition-dependent delays to an input signal) may also include one or more equalizers of various types in its receivers.

In some examples, one possible input signal to the nonlinear feed-forward type equalizer was described as a pulse-amplitude modulated (PAM) signal with four analog levels representing two bits of information. However, the nonlinear feed-forward type equalizers described herein may also be used to improve the performance of an optical transmitter that includes a VCSEL when it is presented with other types of input signals, including more or less complex signals having any number of levels. For example, the nonlinear feed-forward type equalizers described herein may improve the performance of an optical transmitter that includes a VCSEL regardless of the type of modulation and/or encoding scheme that was applied to generate the input signal.

In various embodiments, the methods and systems for nonlinear transmitter equalization disclosed herein may be implemented in high performance enterprise servers and routers, or, in general, in any type of telecommunication equipment or system that implements optical transmission at high speeds. For example, while FIG. 1 illustrates an optical network that may typically be used for long haul optical communications, in other embodiments, the nonlinear feed-forward equalizers described herein may also be used for short reach optical interconnects (e.g., interconnects within a single rack). In various embodiments, these nonlinear equalizers may, by applying transition-dependent delays to various taps in a delay line, compensate for at least some of the inherent nonlinearities of the VCSELs that receive the output of these equalizers. For example, they may improve the signal amplitude for a VCSEL even when operating at very high data rates, allowing the information encoded in the input signal to be distinguishable in the output of the VCSEL (and thus, in the optical signal transmitted in the optical network).

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A nonlinear feed-forward equalizer, comprising:
a delay line comprising:
a plurality of delay elements, each of which is to receive an input signal, to add a delay to the input signal, and to produce an output signal for the delay element; and
a respective delay line tap on the output of each delay element in the delay line; and
a combining circuit to combine contributions from each of the respective delay line taps to generate an output signal of the nonlinear feed-forward equalizer,
wherein for a first one of the plurality of delay elements, the amount of the delay added to the input signal for rising transitions is different than the amount of the delay added to the input signal for falling transitions.

2. The nonlinear feed-forward equalizer of claim 1,
wherein for a second one of the plurality of delay elements:
the amount of the delay added to the input signal for the rising transitions is different than the amount of the delay added to the input signal for the falling transitions; and
the amount of the delay added to the input signal for the rising transitions or for the falling transitions is different than the amount of the delay added to the input signal by the first one of the plurality of delay elements.

3. The nonlinear feed-forward equalizer of claim 1,
wherein the combining circuit is to generate the output signal of the nonlinear feed-forward equalizer by summing the contributions from each of the respective delay line taps.

4. The nonlinear feed-forward equalizer of claim 1, further comprising:
a plurality of tap weighting circuits, each to apply a tap-specific weighting to a respective one of the delay line taps and to generate the contribution from the respective one of the delay line taps as a weighted contribution.

5. The nonlinear feed-forward equalizer of claim 1, further comprising:
a plurality of tap weighting circuits, each to apply a tap-specific weighting to a respective one of the delay line taps and to generate the contribution from the respective one of the delay line taps as a weighted contribution, wherein the tap-specific weighting applied to the delay line tap for a rising transition is different than the tap-specific weighting applied to the delay line tap for a falling transition.

6. The nonlinear feed-forward equalizer of claim 1,
wherein each of the plurality of delay elements comprises a first electrical path that controls the amount of the delay added to the input signal for rising transitions and a second electrical path that controls the amount of the delay added to the input signal for falling transitions.

7. The nonlinear feed-forward equalizer of claim 6,
wherein each of the first electrical path and the second electrical path in a given delay element comprises:
an NMOS transistor; and
a PMOS transistor; and
wherein the given delay element is to receive:
a first pair of control voltages for the NMOS transistor and the PMOS transistor in the first electrical path that determine the amount of the delay added to the input signal on the first electrical path; and
a second pair of control voltages for the NMOS transistor and the PMOS transistor in the second electrical path that determine the amount of the delay added to the input signal on the second electrical path.

8. The nonlinear feed-forward equalizer of claim 1,
wherein for the first one of the plurality of delay elements, a delay is added to the input signal for rising transitions and no delay is added to the input signal for falling transitions.

9. The nonlinear feed-forward equalizer of claim 1,
wherein for the first one of the plurality of delay elements, a delay is added to the input signal for falling transitions and no delay is added to the input signal for rising transitions.

10. An optical transmitter, comprising:
a nonlinear feed-forward equalizer comprising independent delay controls for different transition types exhibited by an input signal; and
a vertical cavity surface emitting laser (VCSEL);
wherein an output of the nonlinear feed-forward equalizer is an input to the VCSEL.

11. The optical transmitter of claim 10,
wherein the nonlinear feed-forward equalizer compensates for at least a portion of a nonlinearity of the VCSEL.

12. The optical transmitter of claim 10,
wherein the nonlinear feed-forward equalizer comprises a plurality of delay elements, each to apply a different amount of delay to rising transitions exhibited by the input signal than to falling transitions exhibited by the input signal.

13. The optical transmitter of claim 10,
wherein the nonlinear feed-forward equalizer is to apply longer delays to rising transitions exhibited by the input signal than to falling transitions exhibited by the input signal.

14. The optical transmitter of claim 10,
wherein the nonlinear feed-forward equalizer is to apply longer delays to falling transitions exhibited by the input signal than to rising transitions exhibited by the input signal.

15. The optical transmitter of claim 10,
wherein the input signal is encoded as a multilevel signal comprising three or more analog levels; and
wherein the nonlinear feed-forward equalizer comprises a plurality of delay elements, each to apply different amounts of delay for each of multiple different transitions between different ones of the three or more analog levels.

16. A method for optical transmission, comprising:
receiving, by a nonlinear feed-forward equalizer, an input signal to be transmitted over an optical network;
directing the input signal to a first delay element in a delay line;
applying, by the first delay element, a delay that is dependent on whether a rising transition is present in the input signal or a falling transition is present in the input signal to generate a first delayed output signal; and
applying, by a first tap weighting element, a tap-specific weighting to the first delayed output signal to generate a first contribution to an output of the nonlinear feed-forward equalizer.

17. The method of claim 16, further comprising:
for each of one or more subsequent delay elements in the delay line and subsequent tap weighting elements:
receiving a respective delayed output signal from a preceding delay element in the delay line as its input signal;
applying, by the delay element, a delay that is dependent on whether a rising transition is present in its input signal or a falling transition is present in its input signal to generate a respective delayed output signal;
applying, by the tap weighting element, a tap-specific weighting to the respective delayed output signal to generate a respective contribution to the output of the nonlinear feed-forward equalizer;
combining the first contribution to the output for the nonlinear feed-forward equalizer and the respective contributions to the output for the nonlinear feed-forward equalizer for each of the one or more subsequent delay elements in the delay line and subsequent tap weighting elements to generate the output of the nonlinear feed-forward equalizer; and
directing the output of the nonlinear feed-forward equalizer to a vertical cavity surface emitting laser (VCSEL) as an input signal.

18. The method of claim 17, wherein the output of the nonlinear feed-forward equalizer compensates for at least a portion of a nonlinearity of the VCSEL.

19. The method of claim 18, further comprising:
determining that rising transitions or falling transitions of the input signal are under-equalized at a tap on the output of the first delay element or on one of the subsequent delay elements in the delay line; and
in response to said determining:
decreasing the weighting for the tap; and
increasing the delay for transitions of the type that is under-equalized in the first delay element or in the one of the subsequent delay elements in the delay line.

20. The method of claim 18, further comprising:
determining that rising transitions or falling transitions of the input signal are over-equalized at a tap on the output of the first delay element or on one of the subsequent delay elements in the delay line; and
in response to said determining:
increasing the weighting for the tap; and
decreasing the delay for transitions of the type that is over-equalized in the first delay element or in the one of the subsequent delay elements in the delay line.
